(19) United States
(12) Patent Application Publication
(10) Pub. No.: US 2021/0276647 A1
(43) Pub. Date: Sep. 9, 2021

(54) SKI ASSEMBLY FOR ATTACHMENT TO A BICYCLE

(71) Applicants: William Connell Nicoll, Calgary (CA); Zach Larson, Calgary (CA)

(72) Inventors: William Connell Nicoll, Calgary (CA); Zach Larson, Calgary (CA)

(21) Appl. No.: 17/194,992

(22) Filed: Mar. 8, 2021

Related U.S. Application Data
(60) Provisional application No. 62/985,967, filed on Mar. 6, 2020.

(51) Int. Cl. B62H 1/14; B62K 25/04

(52) U.S. Cl. CPC B62H 1/14; B62K 25/04

(57) ABSTRACT

A ski assembly for a bicycle includes a mounting frame with a mounting aperture therein and a wheel axle that is received through the mounting aperture of the mounting frame and extends through one of the wheels of the bicycle to mount the wheel relative to the bicycle while supporting the mounting frame in part relative to the bicycle. Two ski members are pivotally supported on respective support arms that are movable relative to the mounting frame by a biasing member that urges the ski member downwardly. The biasing member can be adjusted relative to the mounting frame between a working position in which the ski members are arranged to engage the ground at opposing sides of the wheel of the bicycle and a stored position in which the ski members are supported in raised elevation and out-of-use relative to the working position.

This application claims the benefit under 35 U.S.C. 119(e) of U.S. provisional application Ser. No. 62/985,967, filed Mar. 6, 2020.

### FIELD OF THE INVENTION

The present invention relates to a ski assembly for attachment to a bicycle in which one or more skis are supported alongside the wheels of the bicycle to increase ground contact and stability of the bicycle when the bicycle is used on slippery and/or snow-covered surfaces.

### BACKGROUND

One of the major problems with biking in the snow is the instability of the bike at slow speeds. When encountering snow deeper than a few inches or snow with mixed density or trails with even the slightest of sideward angle the rider will find it very difficult to stay upright on the bike. Not only does the snow make it difficult to stay upright but because of poor traction the rider typically can't go very fast which exacerbates the challenge of maintaining balance.

When you examine the actual dynamics associated with a rider losing their balance in the snow the issue is typically front wheel slide out. If a rider can keep their front wheel from sliding out from beneath them, they can typically ride through any number of snow-covered, slushy or even icy trails. While wider tires can help, even the widest tires on the market today, running with low pressure, often can't prevent front wheel slide out when riding on trails with mixed density snow.

Another major limitation of riding on snow is maintaining traction when going through corners at speed. Unlike riding on dirt trails, even the best fat tires can't maintain the same grip through corners when they are on loose snow. Should the rider attempt to corner as if they were on dirt, the front will washout typically resulting in a crash. Consequently, riders learn that the joy they feel in cornering their mountain bike on dirt trails is typically not available to them on their fat bike. This is far from ideal given one of the great pleasures of mountain biking is going fast through corners on single track trail.

All of these limitations taken as a whole point to one simple reality, today's fat bike technology does not live up to the expectations of riders. As a result, the industry has struggled to keep fat bike riders using their bikes and to attract new riders to the snow biking scene.

### SUMMARY OF THE INVENTION

According to one aspect of the invention there is provided a ski assembly for a bicycle having a rear wheel rotatably supported on a respective rear frame portion and a front wheel rotatably supported on a respective front frame portion, the ski assembly comprising:

one or more mounting frames adapted to be mounted onto one of the frame portions of the bicycle;

at least one ski arrangement supported on the one or more mounting frames, said at least one ski arrangement comprising:
(i) a biasing member coupled to the one or more mounting frames;
(ii) a support arm connected to the one or more mounting frames at least in part by the biasing member; and
(iii) a ski member supported on the support arm at a ski mounting location such that the ski member is movable with the support arm relative to the one or more mounting frame by resiliently deflecting the biasing member;
(iv) the biasing member acting in a direction to bias the ski member downwardly relative to said one or more mounting frames.

The bike snow ski design described herein significantly increases the effective footprint of the front wheel. This is done via the addition of light weight skis that parallel the contact patch of the front tire.

According to one embodiment, the support arm may be a swing arm that is pivotal relative to the one or more mounting frames about a swing arm axis. In this instance, the ski mounting location of said at least one ski arrangement is spaced rearwardly from the swing arm axis. The swing arm axis in this instance is preferably supported forwardly of an axis of rotation of the wheel of the frame portion that supports the one or more mounting frames thereon. Each ski may be attached to the swing arm with the biasing member that provides suspension to provide several inches of travel. The suspension is needed to enable turning, leaning and to address the uneven nature of most trails. Two skis and biasing members are used for a bike, one for the left fork and another for the right. The use of a swing arm allows a high force biasing member with a short travel to apply biasing force over a large range of ski travel, while also enabling the biasing force to be increased as the ski is deflected upwardly from a normal travel position. The biasing member of said at least one ski arrangement is preferably coupled to the swing arm at an intermediate location between the swing arm axis and the ski mounting location, nearer to the swing arm axis than to the ski mounting location.

According to a further embodiment, the biasing member may directly support the ski arrangement for sliding movement relative to the one or more mounting frames. Each ski arrangement may further include a coupling member coupled to the one more mounting frames in which the coupling member is operable to support and/or couple the biasing member to the one or more mounting frames in either one of a working position in which the ski member is arranged to engage the ground or a stored position in which the ski member is supported spaced above the working position. When the biasing member is slidable relative to the one or more mounting frames along a sliding axis from the working position to the stored position, the coupling member may be arranged to retain the biasing member relative to the one or more mounting frames in either selected one of the stored position or the working position. The ski mounting location of the ski member on the support arm may be spaced rearwardly of the sliding axis.

According to either embodiment, the skis are designed to compress the snow underneath them which allows for better turning and horizontal stability. The entire assembly can be displaced up and out of the way into a storage position when the rider no longer needs ski support. The designs have been proven to allow a rider to address all the challenges of riding on snowy/slushy/icy trails. The designs also provide significant benefits should a rider want to go down a steep hill with deep snow. The skis enable the rider to carve through the snow much like a skier would with all the associated fun of doing something new with the bike.

The ski member of said at least one ski arrangement is preferably supported on the support arm so as to be pivotal relative to the support arm about a ski axis oriented substantially parallel to a front wheel axis of the front wheel. The ski member is preferably biased about the ski axis such that a forward end of the ski member is urged upwardly.

The ski mounting location of said at least one ski arrangement is preferably nearer to a rear end of the ski member than a forward end of the ski member.

The biasing member of said at least one ski arrangement is preferably arranged to increase a biasing force that biases the ski member downwardly relative to the one or more mounting frames as the ski member is deflected upwardly against the biasing member.

The biasing member of said at least one ski arrangement may be coupled between the support arm and the one or more mounting frames.

The ski member of said at least one ski arrangement may have a bottom surface which is generally concave in profile between opposing side edges of the ski member.

The ski member may further include at least one rib protruding from a bottom surface of the ski member to extend in a forward working direction of the ski member. The bottom surface may comprise a plastic material and said at least one rib preferably comprises a metal runner.

The ski assembly may further include a wheel axle arranged to couple the one or more mounting frames to the frame portion of the bicycle and support the wheel of the frame portion rotatably thereon. Preferably a clamping member is also arranged to couple the one or more mounting frames to the frame portion of the bicycle at a location spaced from the wheel axle.

The one or more mounting frames are preferably adapted to be mounted on the front frame portion of the bicycle.

Preferably the one or more mounting frames comprise two mounting frames supported the at least one ski arrangement thereon, in which the two mounting frames are arranged to be supported at laterally opposing sides of the frame portion of the bicycle.

### BRIEF DESCRIPTION OF THE DRAWINGS

Some embodiments of the invention will now be described in conjunction with the accompanying drawings in which:

FIG. 1 is a perspective view of the ski assembly supported on a bicycle;

FIG. 2 is a perspective view of one mounting frame and one ski arrangement supported on the mounting frame according to the ski assembly of FIG. 1;

FIG. 3 is a top plan view of the mounting frame and ski arrangement according to FIG. 2;

FIG. 4 is a side elevational view of the mounting frame and ski arrangement according to FIG. 2;

FIG. 5 is a front elevational view of the ski assembly supported on the bicycle according to FIG. 1;

FIG. 6 is a side elevational view of the ski assembly in a normal working position;

FIG. 7 is a side elevational view of the ski assembly in a compressed working position;

FIG. 8 is a side elevational view of the ski assembly in a storage position;

FIG. 9 is a side elevational view of one of the ski members;

FIGS. 10 and 11 are top plan and rear elevational views respectively of the ski member according to FIG. 9;

FIG. 12 is a side elevational view of one of the ski arrangements of the ski assembly according to a second embodiment of the present invention, shown in a working position;

FIG. 13 is a front elevational view of the ski assembly according to the second embodiment of FIG. 12, in which only one ski arrangement is shown supported on a bike and a second ski arrangement has been omitted for illustrative purposes; and

FIG. 14 is a side elevational view of the ski arrangement according to the second embodiment of FIG. 12, shown in a storage position.

In the drawings like characters of reference indicate corresponding parts in the different figures.

### DETAILED DESCRIPTION

Referring to the accompanying figures, there is illustrated a bicycle attachment ski assembly generally indicated by reference numeral 10. The ski assembly 10 is particularly suited for use with a bicycle 12 to increase stability of the bicycle.

A typical bicycle 12 to which the ski assembly 10 can be applied comprises a seat frame 14 that supports a seat 16 for supporting the user thereon and rotatably supports pedals 18 thereon to receive peddling input from the user. The seat frame may directly support a rear wheel 20 of the bicycle rotatably thereon for rotation about a respective wheel axis or the seat frame may further include a rear suspension arm (not shown) which supports the rear wheel rotatably thereon such that the rear wheel can be deflected in elevation relative to the portion of the seat frame supporting the seat and pedals thereon. In either instance the seat frame or the rear suspension arm of the seat frame defines a rear frame portion of the bicycle upon which the rear wheel 20 is rotatably supported.

The typical bicycle 12 further includes a front frame portion 24 supported at a front end of the seat frame for pivotal movement about an upright steering axis. The front frame portion 24 includes handlebars 26 and two front forks 28 which are pivotal together relative to the remainder of the seat frame about the upright steering axis. A front wheel 30 is rotatably supported on the front forks 28 for rotation about a respective wheel axis while being pivotal together with the front frame portion relative to the remainder of the seat frame about the upright steering axis.

The ski assembly 10 according to the either of the illustrated embodiments is suited for attachment to the bicycle in proximity to the front wheel 30 of the bicycle but a similar assembly could be applied to the real wheel in further embodiments.

In the illustrated embodiments, the ski assemblies each comprise two ski arrangements 32 situated at laterally opposing sides of the front wheel by being supported on the front frame portion 24 of the bicycle by two mounting frames 34 respectively. Each ski arrangement 32 is supported by its own mounting frame 34, but the two mounting frames 34 can be mounted onto the front frame portion 24 of the bicycle with some common mounting hardware as described in further detail below.

Each mounting frame 34 generally includes an upright frame member 36 which is secured alongside a respective one of the front forks 28 of the front frame portion. A mounting aperture 38 extends laterally through the upright frame member at a location spaced below the top end thereof for receiving a mounting axle 40 of the ski assembly therethrough. The mounting axle 40 comprises a replacement axle which is inserted through an axle receiving bore in the front wheel and through axle receiving apertures on each of the front forks while also extending through the mounting aperture 38 of each of the mounting frames. In this manner the replacement mounting axle 40 serves to rotatably support the front wheel on the front forks in addition to supporting a portion of the upright frame member 36 of each mounting frame 34 at the outer sides of the front forks respectively. The mounting axle 40 may be a threaded shaft receiving suitable fasteners at opposing ends thereof such as conventional threaded nuts or cam-locking fasteners commonly employed on bicycle axles to releasably clamp the various components listed above along the length of the axle.

In alternative arrangements, the mounting frames 34 may each be mounted onto a respective frame portion of the bicycle by any suitable quick release mechanisms which may be mounted at the axle, or may be mounted apart from the axle, for example at spaced apart locations along the front forks of the bicycle.

To further secure each mounting frame 34 relative to the respective front fork 28 of the bicycle, a clamping member 42 is provided at a location spaced above the mounting axle 40 in proximity to the top end of the upright frame member 36.

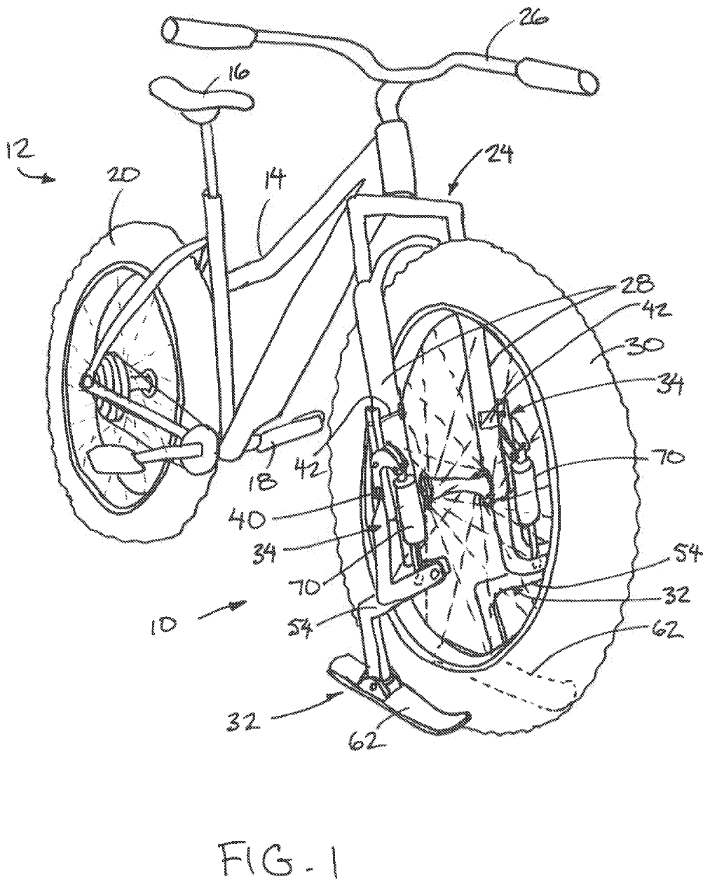

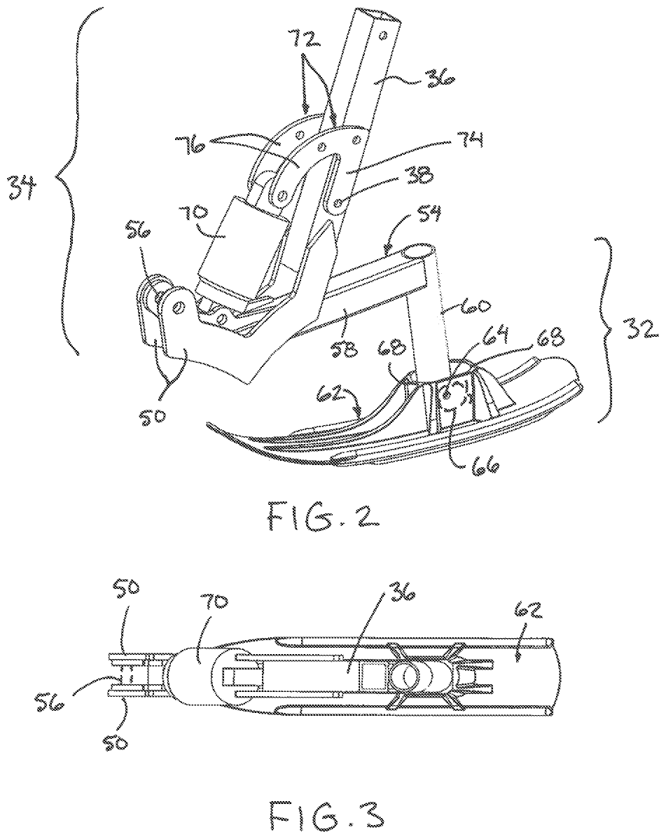

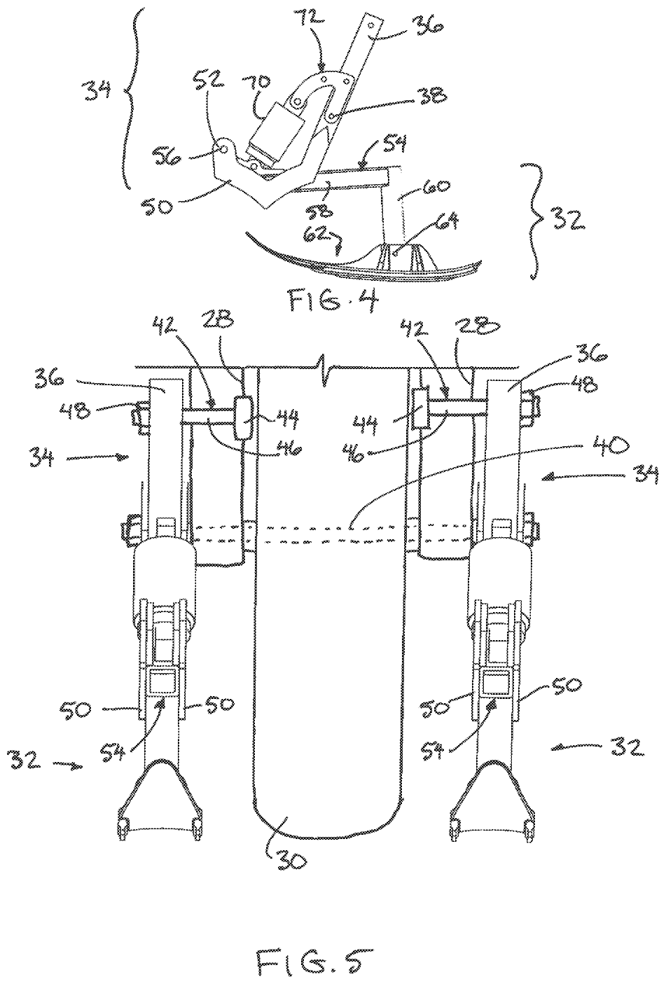

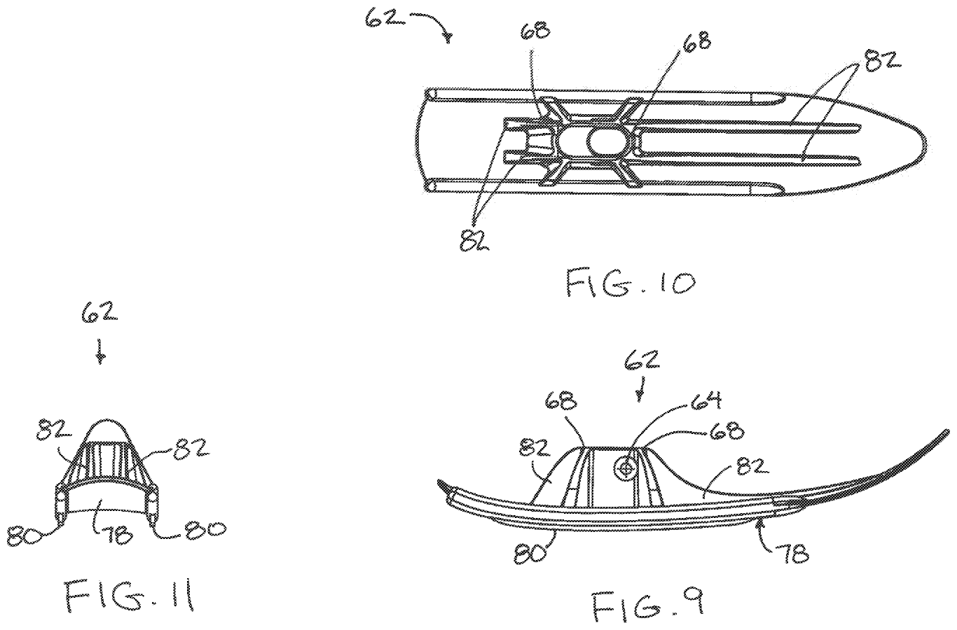

Turning now more particularly to the first embodiment of FIGS. 1 through 11, the clamping member 42 in this instance includes a head portion 44 extending at least partway about the front fork or along an inner side of the front fork and a shaft 46 connected to the head portion 44 to extend through a respective mounting aperture in the upright frame member. A suitable fastener 48 such as a threaded nut or a conventional cam-locking fastener can be secured to the outer end of the shaft to effectively clamp the upper end of the upright frame member 46 to the respective front forks 28 by being clamped between the head portion 44 and the fastener 48 at opposing ends of the shaft 46.

Each mounting frame 34 is thus secured in fixed relation to a respective one of the front forks 28 by the mounting axle 40 at a first location and by the clamping member 42 at a second location spaced radially outward from a wheel axis of the front wheel defined by the mounting axle 40.

Each mounting frame 34 further includes two mounting arms 50 which protrude from the bottom end of the frame member 36 to a forward end 52 which is spaced downwardly and forwardly relative to the mounting axle 40. The mounting arms 50 comprised plates which are parallel to one another and spaced apart by the width of the upright frame member 36 received therebetween such that the mounting arm 50 are provided at laterally opposing sides of the respective upright frame member 36.

Each ski arrangement 32 that is supported on a respective mounting frame 34 includes a support arm 54 which is pivotally coupled by a pivot shaft 56 between the forward ends 52 of the two mounting arms 50, such that the support arm 54 is a swing arm in this instance. The pivot shaft 56 is also located at the front end of the swing arm 54 such that the swing arm includes a main portion 58 extending generally rearwardly from the pivot shaft 56 which defines a swing arm axis about which the swing arm 54 is pivotal. The swing arm axis is parallel to the wheel axis defined by the mounting axle 40. The swing arm 54 further includes a rear leg portion 60 extending generally downward from a rear end of the main portion 58 such that a bottom end of the rear leg portion 60 defines a ski mounting location which is generally spaced below the mounting axle 40.

Each ski arrangement further includes a ski member 62 pivotally supported on a respective pivot shaft 64 mounted at the bottom end of the rear leg portion 60 so as to define the ski mounting location. The ski member 62 is pivotal relative to the swing arm about a ski axis of the pivot shaft 64 which lies parallel to the swing arm axis and the wheel axis.

A spring 66 is operatively connected between the swing arm 54 and the ski member 62 at the pivot shaft 64 so as to bias pivotal movement of the ski relative to the swing arm in a direction which urges the forward end of the ski member upwardly. A pair of stop members 68 are formed on the ski member 62 at locations forwardly and rearwardly of the rear leg portion 60 of the swing arm so as to cause the rear leg portion 60 to engage the stop members 68 at opposing ends of a range of pivotal movement of the ski member relative to the swing arm. The spacing between the stop members 68 effectively defines the amount of pivotal movement of the ski member relative to the swing arm so as to limit over rotation of the ski member into an out-of-use position. The stop members 68 are defined by opposing upright walls of a generally elongated socket receiving the bottom end of the rear leg portion therein and through which the pivot shaft is received to pivotally couple the ski member to the swing arm.

Each ski arrangement 32 further includes a biasing member 70 which is operatively connected between the swing arm 54 of the ski arrangement and the respective mounting frame 34. In the illustrated embodiment, the biasing member 70 is a gas spring which is elongate in a longitudinal direction and which expands and contracts in length linearly between opposing ends of the biasing member. The biasing member is typically mounted under compression so as to provide biasing from a compressed state having a minimum length to an extended state in which the length of the biasing member is increased to urge the ski member downwardly.

The top end of the biasing member is coupled to the mounting frame using a mounting arrangement comprising two coupling members 72 formed of plate material supported parallel and spaced apart from one another at laterally opposing sides of the respective upright frame member 36 received therebetween. More particularly, each coupling member includes a first leg 74 having a mounting aperture at the bottom end thereof which receives the mounting axle 40 therethrough so that the coupling member is pivotal about the mounting axle. The first leg 74 extends generally upward to a top end locating a second mounting aperture therein to selectively receive a pin therethrough which pins the top end of the coupling member to the upright frame member. When pinned, the coupling members are retained in a working position of the ski arrangement, however when the pin is released, the coupling member can be pivoted away from the working position as described in further detail below.

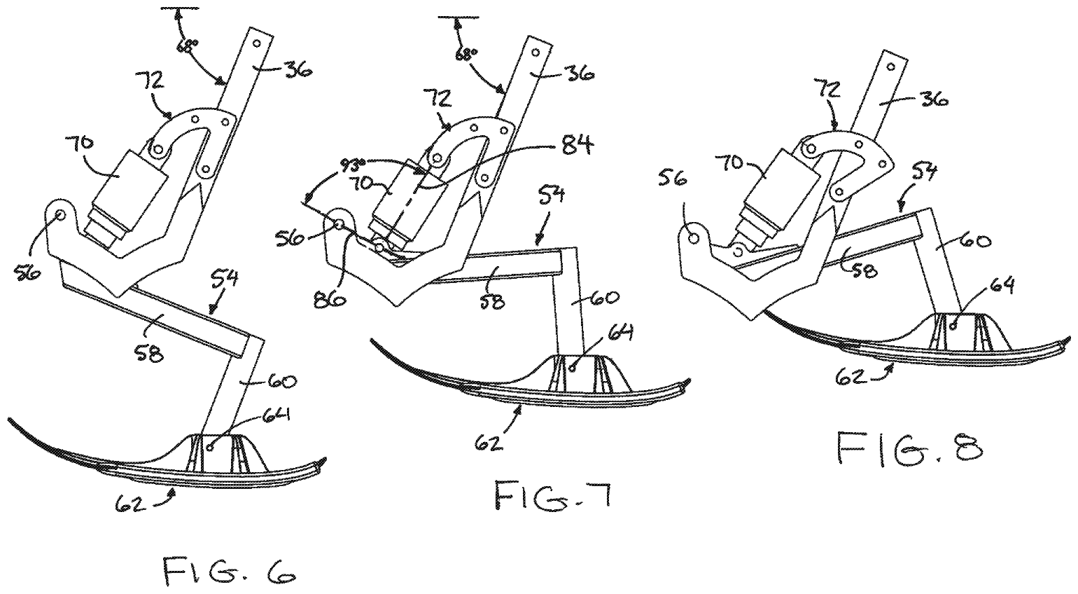

Each coupling member 72 further includes a second leg 76 which protrudes downwardly and forwardly from the top end of the first leg when the first leg is pinned in the working position. The opposing bottom ends of the second legs 76 of the coupling members of each ski arrangement pivotally couple the top end of the respective biasing member 76 therebetween. When the first legs of the coupling members are pinned in the working position as shown in FIGS. 6 and 7, the top end of the biasing member is supported at a first elevation which is near in elevation to the mounting axle 40. However when the pin is removed, the coupling members can be pivoted into a storage position shown in FIG. 8 in which the mounting location of the top end of the biasing member is displaced upwardly relative to the working position to release some of the downward compression applied by the biasing member onto the swing arm and in turn onto the ski member supported on the swing arm. An additional pin receiving aperture within the second legs of the coupling members can selectively retain the coupling members in the storage position according to FIG. 8 when receiving a pin therethrough that engages the upright frame member.

The coupling members themselves may be biased towards the working position by a suitable spring (not shown). In this instance a latch (not shown) may be provided for selectively retaining the coupling members in the storage position against the force applied by the spring. In this instance an actuator member (not shown) can be provided on the handlebars of the bicycle, in which the actuator member is operatively connected by a cable mechanism to the latch such that an operator of the bicycle can activate the actuator member while their hands remain positioned on the handlebars. This will in turn release the latch and allow the spring associated with the coupling members to bias the coupling members into the working position thereof. In the working position, the coupling members support the biasing member to apply biasing force which urges the ski members to engage the ground.

In further embodiments, the coupling members may be replaced with other types of linkages, such as sliding linkages, pivoting linkages, etc., which can similarly support the top ends of the biasing members 70 to be displaced upwardly from a working position to a storage position when desired.

The bottom end of the biasing member 70 of each ski arrangement is pivotally coupled to the respective swing arm 54 at an intermediate location between the swing arm axis at the pivot shaft 56 and the ski mounting location at the pivot shaft 64. More particularly, the biasing member is pivotally coupled to the swing arm at a location which is nearer to the front end of the main portion 58 than the rear end of the swing arm. In this manner a high strength biasing member with a short distance of travel between compressed and extended positions thereof can apply force over a larger range of movement of the ski member due to the ski mounting location being spaced radially outward from the swing arm axis by a radial distance which is much greater than the radial distance to the biasing mounting location on the swing arm.

Each ski member 62 is elongate in the forward working direction of movement of the bicycle between opposing front and rear ends of the ski member. The pivot shaft 64 is coupled to the ski member at a location which is closer to the rear end of the ski member than the front end of the ski member. In the illustrated embodiment, the pivot shaft is approximately located at one third of the overall length of the ski member from the rear end of the ski member.

The ski member has a bottom surface adapted for engaging the ground. The bottom surface 78 has a profile in the longitudinal direction which is convex between opposing front and rear ends of the ski member along the full length thereof. The profile of the bottom surface in the lateral direction perpendicular to the longitudinal direction is instead slightly concave between the opposing side edges of the ski member.

The ski member 62 further includes two protruding ribs 80 which are parallel to one another and spaced apart at the opposing side edges of the ski member so as to be oriented in the longitudinal direction and so as to protrude downwardly from the remainder of the bottom surface 78 of the ski member. Each of the protruding ribs may comprise a metal blade or runner which protrudes downwardly from the plastic material forming the bottom surface 78 and the remainder of the body of the ski member.

The body of the ski member may further include a plurality of stiffener ribs 72 protruding upwardly from an upper surface of the blade body while being oriented in the longitudinal direction to provide structural rigidity to the body of the ski member.

In use, the ski assembly is mounted onto a bicycle by supporting the two mounting frames 34 onto respective ones of the front forks 28 of the bicycle using a mounting axle 40 which replaces the conventional front wheel axle of the bicycle. The additional use of clamping members 42 ensures that the mounting frames 34 are fixed relative to the front frame portion of the bicycle. Each of the mounting frames 34 then supports a respective ski arrangement 32 thereon comprised of a swing arm 54 and a respective ski member 62 so that the overall ski assembly includes two ski members oriented in a forward working direction of the bicycle at laterally opposing sides of the front wheel.

When use of the ski assembly is not required, the coupling members of each ski arrangement can be pivoted into the storage position thereof which supports the ski member in raised elevation relative to the bottom of the front wheel so that the front wheel can engage the ground for normal operation of the bicycle while the ski members remain spaced above the ground in non-contacting relation with the ground. Releasing the pin which retains the coupling members in the storage positions thereof allows the coupling members to be biased into or manually pinned into the working positions thereof.

In the working position of the coupling members, the ski members are movable with extension and retraction of the biasing members 70 between a normal working position with the skis engaged upon the ground as shown in FIG. 6, and a compressed working position in which the skis are deflected upwardly relative to the normal working position as shown in FIG. 7 as a result of sideways leaning of the bicycle or as a result of contact with the ground forcing the skis upwardly. In either instance, the ski members are biased downwardly by the biasing member into engagement with the ground, including compacted snow lying on the ground, even as the elevation of the ground varies so as to increase the contact of the bicycle on the ground compared to the front wheel of the bicycle alone without ski attachments.

The main portion 58 of the swing arm includes a forward portion which extends upwardly and forwardly from the mounting location of the biasing member to the pivot shaft coupling the swing arm to the mounting arms 50 resulting in a geometry of the biasing member relative to the swing arm that tends to provide increasing biasing force as the ski member is deflected upwardly from the normal working position of FIG. 6 to the compressed working position of FIG. 7. More particularly, the interior angle between (i) a linear axis 84 of the biasing member 70 and (ii) an imaginary axis 86 passing through both the swing arm axis and the pivot coupling between the bottom end of the biasing member and the swing arm is near perpendicular in the fully compressed state of the biasing member according to FIG. 7 while being much less than 90 degrees in the normal working position according to FIG. 6 so that the biasing member provides greater downward force in the position of FIG. 7 than in the position of FIG. 6.

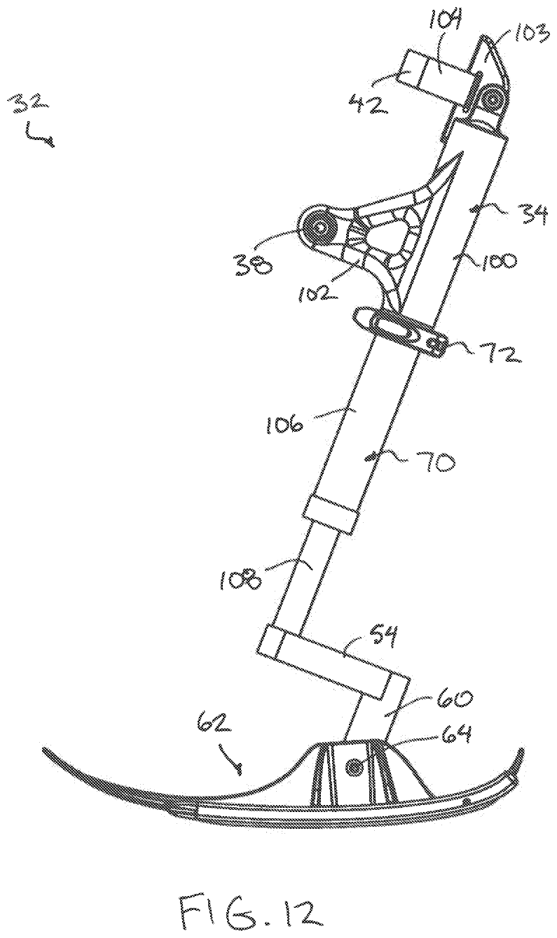

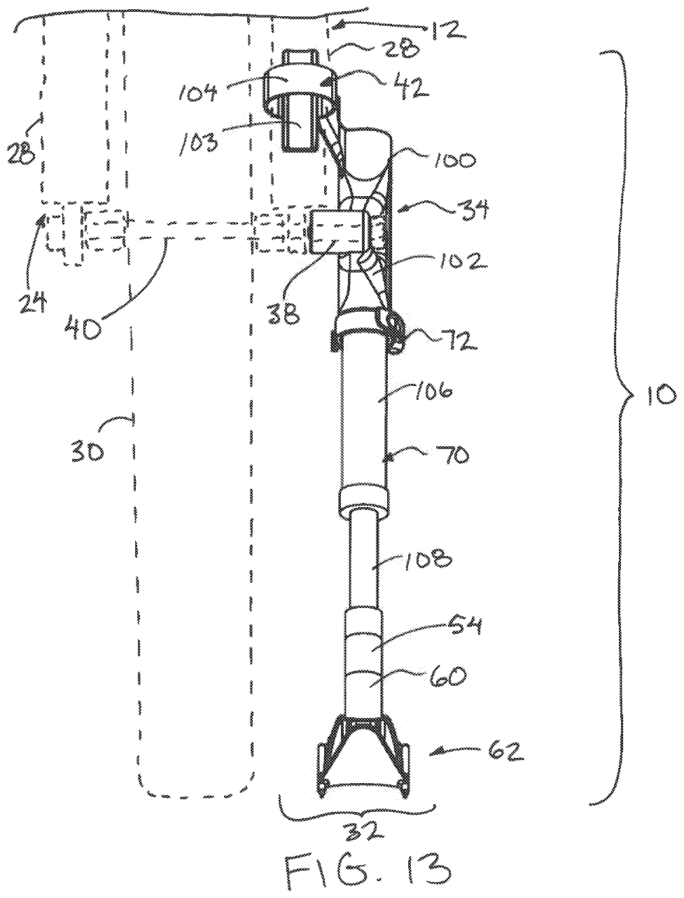

Turning now to the second embodiment of FIGS. 12 through 14, in this instance, the ski assembly 10 again comprises two ski arrangements 32 supported by respective mounting frames 34 on the two forks 28 of the bicycle respectively using a replacement axle 40 extending through the front wheel 30 and through corresponding front wheel mounts on the two forks 28 respectively similarly to the previous embodiment.

The mounting frame 34 in this instance differs in that the mounting frame comprises an upright sleeve 100 connected to the clamp 42 at the top end thereof and locating the mounting aperture 38 that receives the axle 40 on a bracket portion 102 at an intermediate location along the sleeve. The clamp 42 in this instance comprises a bracket 103 arranged to be secured against the respective fork 28 by a suitable strap 104 in which the bracket 103 is pivotally coupled to the top end of the sleeve 100 for pivotal movement about a pivot axis that is parallel to the wheel axis. The bracket portion 102 of the mounting frame 34 is fixed relative to the sleeve 100 to project forwardly therefrom to locate the mounting aperture 38 therein at a location spaced forwardly of a longitudinal axis of the sleeve so that the sleeve is mounted along a rear side of the respective fork 28 of the bicycle to extend above the wheel axle 40. The sleeve 100 is held fixed and immovably relative to the front frame portion of the bicycle by the combination of the mounting axle 40 and the clamp 42.

The biasing member 70 has a cylinder portion 106 slidably receiving a piston portion 108 therein and is mounted under compression in a working position. More particularly, the biasing member is a shock absorber including a cylinder portion 106 slidably receiving a piston portion 108 therein to vary an overall length of the shock absorber in which the biasing acts to bias the piston portion 108 outwardly from the cylinder portion. The biasing member spring is typically mounted under compression in a working position such that the biasing force urges ski member mounted on the piston member 108 downwardly into positive engagement with the ground.

The biasing member 70 may comprise a gas spring as in the previous embodiment, or more preferably, the biasing member 70 includes a metal spring mounted within the cylinder portion 106 under compression to bias the piston portion 108 outwardly. An elastomeric material may be further incorporated into the biasing member to provide motion dampening.

The cylinder 106 includes an outer circumference that closely matches the inner circumference of the sleeve 100 of the mounting frame such that the biasing member is longitudinally slidable within the sleeve 100 to be adjustable in height therebetween between different mounted positions of the biasing member relative to the mounting frame. The biasing member is slidably adjustable in height relative to the mounting frame along a sliding axis.

A coupling member 72 is provided in the form of a clamp fixed to the bottom end of the sleeve 100 and which can be operated between an engaged position circumferentially constricting about the cylinder 106 to fix the cylinder immovably relative to the sleeve 100 and a released position in which the cylinder is slidably adjustable in height relative to the surrounding sleeve 100 without restriction by the coupling member 72.

A support arm 54 in this instance is mounted fixedly to the bottom end of the piston portion 108 of the biasing member which in turn supports the ski member 62 therebelow such that the biasing member 70 solely supports the support arm and ski member relative to the mounting frame 34 in this instance. The support arm 54 extends radially outward from the bottom end of the piston portion 108 in a rearward orientation. A rear leg 60 depends downward from the rear end of the support arm 54 in parallel and rearward offset relation relative to the sliding axis of the cylinder portion 106 and sleeve 100. The rear leg 60 is fixed in relation to the support arm 54 and is coupled to the ski member 62 at the bottom end thereof by a shaft 64 defining a pivot axis of the ski member relative to the rear leg 60 and support arm 54.

The configuration of the ski member 62 and the pivotal connection thereof by the shaft 64 onto the rear leg 60 is substantially identical to the previous embodiment such that the ski member 62 is biased about the ski axis to urge the forward tip of the ski upwardly while allowing the ski to deflect through a range of motion defined by two opposing stops 68 as described above with regard to the previous embodiment.

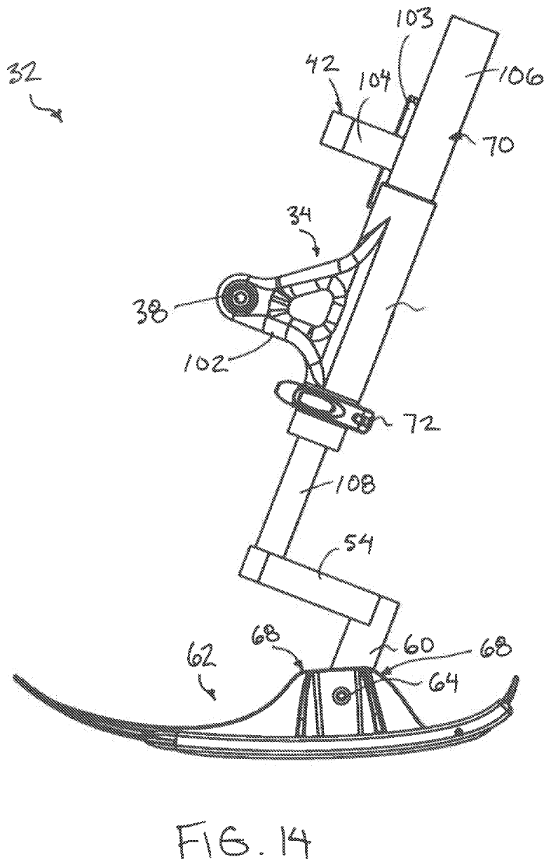

When additional support from the ski members is desired, each of the coupling members 72 may be disengaged so that the cylinder portion 106 of each biasing member can be displaced downwardly into a working position of the ski assemblies according to FIGS. 12 and 13. In this instance the ski members are arranged to engage the ground while being biased downwardly by the biasing member 70 to maintain positive engagement with the ground. The coupling member 72 allows the height of the cylinder to be fixed at any one of numerous height relative to the mounting frame in the working position to control the amount of downforce provided by the spring and to accommodate different bike configurations or wheel diameters for example.

When use of the ski members is no longer required, the coupling members 72 can be released so that the cylinder portions of the biasing members can be slidably displaced upward from the working position to the storage position which supports the ski members to be raised in elevation relative to the working position to a height which causes the ski members to be spaced above the ground and out of use. Returning the coupling members 72 to the engaged position retains the ski arrangements in the stored position of FIG. 14.

Since various modifications can be made in my invention as herein above described, and many apparently widely different embodiments of same made, it is intended that all matter contained in the accompanying specification shall be interpreted as illustrative only and not in a limiting sense.

1. A ski assembly for a bicycle having a rear wheel rotatably supported on a respective rear frame portion and a front wheel rotatably supported on a respective front frame portion, the ski assembly comprising:
one or more mounting frames adapted to be mounted onto one of the frame portions of the bicycle;
at least one ski arrangement supported on the one or more mounting frames, said at least one ski arrangement comprising:
(i) a biasing member coupled to the one or more mounting frames;
(ii) a support arm connected to the one or more mounting frames at least in part by the biasing member; and
(iii) a ski member supported on the support arm at a ski mounting location such that the ski member is movable with the support arm relative to the one or more mounting frame by resiliently deflecting the biasing member;
(iv) the biasing member acting in a direction to bias the ski member downwardly relative to said one or more mounting frames.

2. The ski assembly according to claim 1 wherein the support arm is a swing arm that is pivotal relative to the one or more mounting frames about a swing arm axis and wherein the ski mounting location of said at least one ski arrangement is spaced rearwardly from the swing arm axis.

3. The ski assembly according to claim 2 wherein the swing arm axis of said at least one ski arrangement is supported forwardly of an axis of rotation of the wheel of the frame portion that supports the one or more mounting frames thereon.

4. The ski assembly according to claim 2 wherein the biasing member of said at least one ski arrangement is coupled to the swing arm at an intermediate location between the swing arm axis and the ski mounting location.

5. The ski assembly according to claim 2 wherein the biasing member of said at least one ski arrangement is coupled to the swing arm nearer to the swing arm axis than to the ski mounting location.

6. The ski assembly according to claim 1 wherein the ski member of said at least one ski arrangement is supported on the support arm so as to be pivotal relative to the support arm about a ski axis oriented substantially parallel to a front wheel axis of the front wheel.

7. The ski assembly according to claim 6 wherein the ski member of said at least one ski arrangement is biased about the ski axis such that a forward end of the ski member is urged upwardly.

8. The ski assembly according to claim 1 wherein the ski mounting location of said at least one ski arrangement is nearer to a rear end of the ski member than a forward end of the ski member.

9. The ski assembly according to claim 1 wherein the biasing member of said at least one ski arrangement is arranged to increase a biasing force that biases the ski member downwardly relative to the one or more mounting frames as the ski member is deflected upwardly against the biasing member.

10. The ski assembly according to claim 1 wherein the biasing member of said at least one ski arrangement is coupled between the support arm and the one or more mounting frames.

11. The ski assembly according to claim 1 wherein said at least one ski arrangement further comprises a coupling member coupled to the one more mounting frames, the coupling member being operable to couple the biasing member to the one or more mounting frames in a working position in which the ski member is arranged to engage the ground and in a stored position in which the ski member is supported spaced above the working position.

12. The ski assembly according to claim 11 wherein the biasing member is slidable relative to the one or more mounting frames along a sliding axis from the working position to the stored position and wherein the coupling member is arranged to retain the biasing member relative to the one or more mounting frames in either selected one of the stored position or the working position.

13. The ski assembly according to claim 12 wherein the ski mounting location of the ski member on the support arm is spaced rearwardly of the sliding axis.

14. The ski assembly according to claim 1 wherein the ski member of said at least one ski arrangement has a bottom surface which is generally concave in profile between opposing side edges of the ski member.

15. The ski assembly according to claim 1 wherein the ski member of said at least one ski arrangement includes at least one rib protruding from a bottom surface of the ski member to extend in a forward working direction of the ski member.

16. The ski assembly according to claim 15 wherein the bottom surface comprises a plastic material and said at least one rib comprises a metal runner.

17. The ski assembly according to claim 1 further comprising a wheel axle arranged to couple the one or more mounting frames to the frame portion of the bicycle and support the wheel of the frame portion rotatably thereon.

18. The ski assembly according to claim 17 further comprising a clamping member arranged to couple the one or more mounting frames to the frame portion of the bicycle at a location spaced from the wheel axle.

19. The ski assembly according to claim 1 wherein the one or more mounting frames are adapted to be mounted on the front frame portion of the bicycle.

20. The ski assembly according to claim 1 wherein the one or more mounting frames comprise two mounting frames supported the at least one ski arrangement thereon, the two mounting frames being arranged to be supported at laterally opposing sides of the frame portion of the bicycle.
